(19) United States
(12) Patent Application Publication
(10) Pub. No.: US 2012/0045154 A1
(43) Pub. Date: Feb. 23, 2012

(54) Multiblade Gasodynamic Bearing

(76) Inventor: Yury Ivanovich Ermilov, Moscow (RU)

(21) Appl. No.: 12/673,164

(22) PCT Filed: Jul. 9, 2008
(86) PCT No.: PCT/RU08/00449

§ 371 Date: Feb. 11, 2010

(51) Int. Cl. F16C 32/06

(52) U.S. Cl. 384/103

(57) ABSTRACT

The invention is related to mechanical engineering in particular to compliant foil hydrodynamic bearings which is used in small-size high speed machines such as turbocompressors, cooling turbines etc. The inventive foil hydrodynamic bearing comprises a bearing case (7), a journal (1), several compliant smooth top foil (15) and elastically damping sections, each of which consists of a spring element (25) (for example, a corrugated foil) and compliant smooth inner foils (27, 30, 33), which are fixed by one end thereof to the bearing case on both sides of the spring element. The increased frictional damping of the bearing at small rotating frequencies is obtained by that, when the journal 1 is shifted, a sliding motion with friction takes place between the contacting surfaces of the inner foils of the elastically damping sections.

### TECHNICAL FIELD

The invention is related to mechanical engineering in particular to compliant foil hydrodynamic bearings which is used in small-size high speed machines such as turbocompressors, cooling turbines etc.

### BACKGROUND ART

The known foil hydrodynamic bearing (U.S. Pat. No. 5,634,723) comprises the bearing case, the journal, disposed inside the bearing case, several compliant smooth top foils, disposed in the circumferential direction in the space between the inner cylindrical bearing case surface and the journal. The spring element in form of corrugated foil is disposed between the inner bearing case surface and each top foil. The compliant smooth inner foil is disposed between each top foil outer surface and the corresponding spring element inner surface. Each inner foil is fixed by one end thereof to the top foil that is disposed next to said inner foil in the circumferential direction.

The bearing load capacity of some foil hydrodynamic bearing increases under other constant factors when the angle length of gas lubricating layer, disposed between each top foil inner surface and the journal surface increases. It means that it is necessary to reduce the quantity of top foils in the bearing in order to increase said bearing load capacity.

At small rotation speed the known foil hydrodynamic bearing (U.S. Pat. No. 5,634,723) has reduced damping capacity in case of small quantity of top foils, for example equal to three. The reason is that at radial journal oscillations in the direction of some top foil there is no sliding between the top foil and inner foil disposed radially outwardly of said top foil. Said sliding does not appear because part of said top foil is in the zone where there are big thickness and small over pressure in the lubricating layer. While one part of said top foil with small thickness of lubricating layer radially displaces from the bearing centre, another part of said top foil with big thickness of lubricating layer straitens up and expands without sliding between the top and inner foil.

Reduced damping capacity of said foil hydrodynamic radial bearing at small journal rotation speed is a disadvantage because resonant rotor oscillations arise in bearings at start/stop. Low damping causes an increase in magnitude of resonant rotor oscillations and leads to necessity to increase radial gaps between stationary parts and compressor wheel or turbine wheel that decreases high speed machines efficiency.

### SUMMARY OF THE INVENTION

The object of the presented invention is to increase damping capacity of foil hydrodynamic radial bearing at small rotor revolution speed.

The appointed object is achieved by the following way. The foil hydrodynamic radial bearing comprises the bearing case with journal, two or more compliant smooth top foils..

Said top foils are disposed in the annular space between the bearing case inner surface and the journal and they extend around the journal. Said top foils adjoin by their inner surface to the journal. One end of the top foil is fixed in the direction of bearing axis to the bearing case. Between each top foil outer surface and the bearing case inner surface there are disposed in the circumferential direction two or more elastically damping sections. Each of said sections comprises the spring element (for example, a corrugated foil) adjoined by its outer side to the bearing case and two or more compliant smooth inner foils disposed between the spring element inner surface and the top foil outer surface. One end of inner foil is fixed in direction of the bearing axis to the bearing case. Between each top foil and the bearing case there is disposed at least one elastically damping section wherein two contacting inner foils are fixed to the bearing case near opposite ends of the spring element.

### DESCRIPTION OF THE EMBODIMENT

Embodiment of the present invention is explained below by reference to the attached drawing.

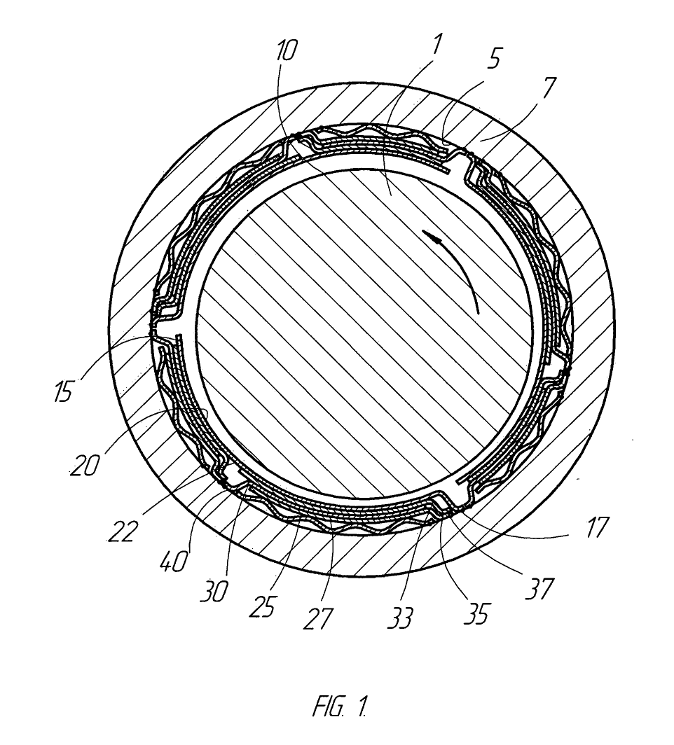

FIG. 1 illustrates the cross sectional view of the radial foil hydrodynamic bearing.

The foil hydrodynamic radial bearing comprises the rotor journal 1 disposed inside the hole of the bearing case 7. Compliant smooth top foils 15 adjoined by inner surfaces 20 to the rotor journal 1 are disposed in annular space between the inner surface 5 of the bearing case 7 and the surface 10 of the journal 1 The end 17 of top foil is fixed in the direction of bearing axis to the bearing case, for example by welding. The top foil extends around the journal. The unfixed end of said top foil forms a small gap with the fixed part of next top foil.

Several (at least two) elastically damping sections are disposed in the circumferential direction between the outer surface 22 of each top foil and the bearing case inner surface. The bearing shown in FIG. 1 has two such sections under each top foil. Each elastically damping section comprises the spring element (for example, a elastic corrugated foil) 25 and compliant smooth inner foils 27, 30, 33. The inner foil 27 contacts by its outer surface with the spring element inner surface. The inner foil 30 contacts by its outer surface with the inner surface of inner foil 27. The inner foil 33 contacts by its outer surface with the inner surface of inner foil 30. The number of inner foils in the elastically damping section may be equal to two or more. The inner foils 27, 30 and 33 are fixed near spring element 25 to the bearing case along one end in the direction of bearing axis. One of the manners to fix inner foils is welding. The inner foils 27 and 30 are directly fixed by parts 35 and 40 to the bearing case. If number of inner foils in the section more than two, part of inner foils may be fixed to the bearing case by fixing parts of underlying inner foils. For example, overlying inner foil 33 is fixed by its part 37 to the bearing case thorough fixing part 35 of the underlying inner foil 27. FIG. 1 shows one of possible variants to dispose inner foils fixing parts in the section wherein each pair of contacting inner foils (pair of foils 27 [symbol] 30, pair of foils 30 [symbol] 33) is fixed to the bearing case near opposite ends of the spring element.

In the operation of the foil hydrodynamic bearing-according to the embodiment of the present invention, rotating journal surface 10 entrains in the circumferential direction the air in lubricating layers between top foils inner surfaces 20 and the journal surface 10, that is from inlet to outlet disposed at free end and fixed end 17 of each top foil correspondently.

For the top foil 22 disposed in the direction of bearing load it correspondents to air movement in said layer from its big to small thickness. For said top foil air pressure in lubricating layer increases with decrease in layer thickness by reason of air viscosity. At some rotation speed the value of pressure becomes sufficient to prevent contact between the journal 1 and the top foils inner surfaces 20.

FIG. 1 shows the variant of disposing bearing where bearing load under rotor weight passes to the low part of bearing case in the zone of small thickness in lubricating layer. At small rotation speed, big lubricating layer overpressure is only in said zone and main part of bearing load is passed to the bearing case through the top foil disposed in low part of the bearing and the low elastically damping section: inner foils 33, 30, 27 and the spring element 25.

Arising oscillations of the rotating shaft in the foil hydrodynamic radial bearing are accompanied with frictional damping because of sliding bearing elements relatively each other: top and inner foils, spring elements and the bearing case.

At vertical oscillations of the shaft and small rotation speed the main part of frictional damping is generated at the bearing low part where contact pressure between bearing elements is maximal.

When the journal moves down, the top foil and elastically damping section inner foils displace down under lubricating layer pressure, inner and outer surfaces of the inner foil 30 displace relatively the bearing case in a clockwise direction to fixing part of inner foil 30. Surfaces of inner foils 33 and 27 displace in a counterclockwise direction. Said displacement of contacting inner foils in different directions generates friction forces between inner foils 33 and 30 and between inner foils 30 and 27. Angle length of elastically damping sections is so that practically all low part of said section is disposed in high pressure zone and small thickness of lubricating layer. That is why under friction forces the inner foils in said section cannot approach to the journal and straighten, so they have to slide relatively each other generating frictional damping. When the journal moves up, that is in backward direction, inner foils of said section return to the initial place and also slide relatively each other generating frictional damping.

When the shaft oscillates in another direction or in case of shaft circular precession, by the same way, as a result of journal movement, there arises friction damping in other deforming elastically damping sections.

Friction damping between inner foils of elastically damping section increases at increase in number of inner foils contacting couples. If the elastically damping section has only two inner foils, there is one inner foil contacting couple. If the elastically damping section has three inner foils, as it is shown in FIG. 1, there are two inner foils contacting couples and in this case the friction damping will be more than at two inner foils in the section.

1. A foil hydrodynamic bearing, comprising:
a journal disposed inside the hole of the bearing case;
two or more compliant top foils disposed in the annular space between the bearing case inner surface and the journal, said top foils extending around the journal and adjoining by their inner surfaces to the journal, and fixed in in the direction of bearing axis by one end thereof to the bearing case;
at least one elastically damping section, disposed in the circumferential direction between each top foil outer surface and the bearing case inner surface,
comprising:
the spring element disposed between the top foil outer surface and the bearing case inner surface and
at least two compliant inner foils disposed between the spring element inner surface and the top foil outer surface, and fixed in the direction of bearing axis by one end thereof to the bearing case;
wherein
at least two elastically damping sections are disposed at least between one of top foils and the bearing case and
between each top foil and the bearing case there is disposed at least one elastically damping section wherein two contacting inner foils are fixed to the bearing case near opposite ends of the spring element.

2. The bearing according to claim 1 wherein the top foils and inner foils are smooth

3. The bearing according to claim 1 wherein the spring element is made of corrugated foil.

4. The bearing according to claim 1 wherein each top foil extended from unfixed end to the fixed end thereof in the direction of rotor rotating.

5. The bearing according to claim 1 wherein each elastically damping section comprises contacting inner foils fixed to the bearing case near opposite ends of the spring element.

6. The bearing according to claim 1 wherein top foils and inner foils are fixed to the bearing case by welding.
